(19) United States
(12) Patent Application Publication
(10) Pub. No.: US 2016/0253691 A1
(43) Pub. Date: Sep. 1, 2016

(54) Method of Generating and Delivering Digital Product Coupons through Reverse Micro Coupon Auctions by Executing Computer-Executable Instructions Stored On a Non-Transitory Computer-Readable Medium

(71) Applicants: EDWARD DANTE, III, Pleasanton, CA (US); Scarlett Angeline Dante, Pleasanton, CA (US)

(72) Inventors: EDWARD DANTE, III, Pleasanton, CA (US); Scarlett Angeline Dante, Pleasanton, CA (US)

(21) Appl. No.: 15/055,528

(22) Filed: Feb. 26, 2016

Related U.S. Application Data
(60) Provisional application No. 62/121,185, filed on Feb. 26, 2015.

(51) Int. Cl. G06Q 30/02

(52) U.S. Cl. CPC G06Q 30/0207; G06Q 30/0269; G06Q 30/0267; G06Q 30/0275

(57) ABSTRACT

A method of generating and delivering digital product coupons through reverse micro coupon auctions allows users to select digital coupons for various products and goods in a retail store. The user scans a barcode of an item or enters the item manually through the user interface of a “smart” mobile device application and is presented with digital coupons offering discounts for similar products and bidding to win the customer's business. Manufacturers can define the discount value and bidding parameters of coupons and target various demographics and locations. Manufacturers are also offered analytics to evaluate the success of their coupon campaigns. Various other features are provided in the mobile device application, such as a store locator and savings comparison tool, shopping lists and a store mapping feature.

The current application claims a priority to the U.S. Provisional Patent application serial number 62/121,185 filed on Feb. 26, 2015.

### FIELD OF THE INVENTION

The present invention relates generally to purchasing goods. More particularly, the present invention relates to delivery of digital coupons for products.

### BACKGROUND OF THE INVENTION

Present day, a shopper in a store may need to prepare beforehand if they wish to utilize coupons. Older methodologies include manual clipping with scissors and physically carrying the coupons with them to the store. Prior art includes various digital methods of couponing.

However, such prior art does not include the capability for manufacturers to bid on the right to display their coupons more prominently, nor in-store locator mapping to help shoppers locate discount goods. It is therefore an objective of the present invention to introduce a device that users can utilize to overcome such problems.

### BRIEF DESCRIPTION OF THE DRAWINGS

FIG. 1 is a stepwise flow diagram describing the general method of the present invention.

FIG. 2 is a stepwise flow diagram describing steps for identifying a product, and calculating a discount values and savings.

FIG. 3 is a stepwise flow diagram describing steps for controlling coupon bidding parameters and delivering promotional coupons.

FIG. 4 is a stepwise flow diagram describing steps for calculating and displaying a total savings value to the customer.

FIG. 5 is a stepwise flow diagram describing steps for compiling and delivering analytical records to manufacturers.

FIG. 6 is a stepwise flow diagram describing steps for utilizing the store locator feature.

FIG. 7 is a stepwise flow diagram describing steps for utilizing the store mapping feature.

FIG. 8 is a stepwise flow diagram describing steps for implementing the community shopping list feature.

FIG. 9 is an illustration of scanning a product's barcode in the mobile device application.

FIG. 10 is an illustration of the reverse micro auction screen in the mobile device application.

FIG. 11 is an illustration of coupons applied to the shopping list in the mobile device application.

FIG. 12 is an illustration of the manufacturer's campaign manager interface.

FIG. 13 is an illustration of the manufacturer's demographic management interface.

FIG. 14 is an illustration of the manufacturer's analytics interface.

FIG. 15 is an illustration of the shopping lists screen in the mobile device application.

FIG. 16 is an illustration of the store mapping feature in the mobile device application.

FIG. 17 is a diagram of the general structure of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

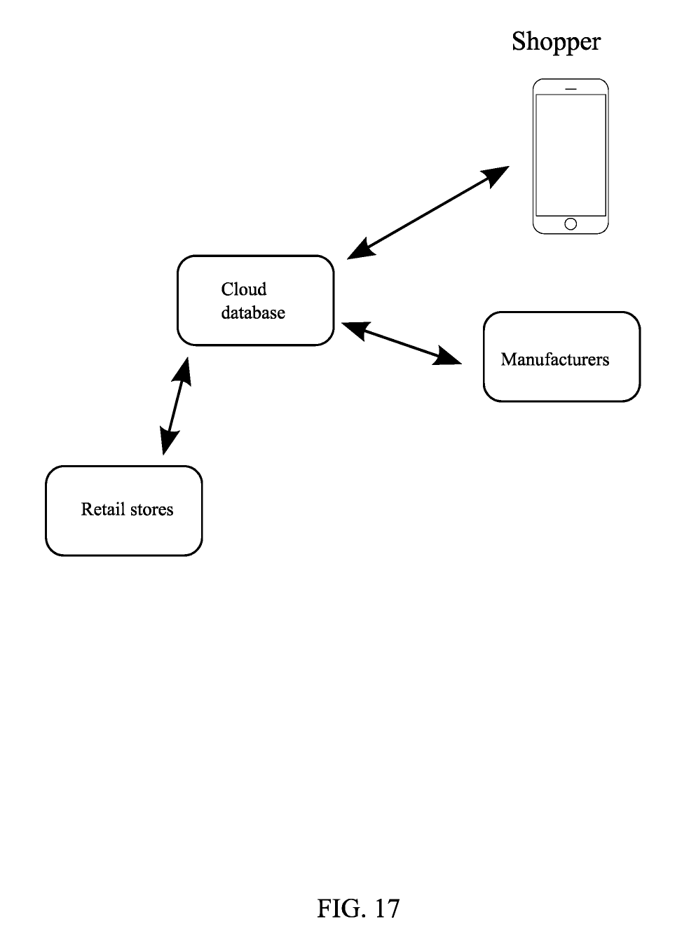

The present invention is implemented in the form of a software application running on a “smart” mobile enabled device, or smartphone, in which the shopper identifies items to be purchased. Additionally, the present invention is stored and executed primarily from a database or multiple databases containing all relevant information that is read and processed by one or more processing units. The present invention also relies on network connections such as, but not limited to, the internet and mobile networks, to facilitate communication among various parties such as, but not limited to, manufacturers, customers, and stores. A major component and process of the present invention is a hosted cloud real-time data based linkage. This linkage ties together and corresponds between the mobile device shopping application, the manufacturer portal, and the store product and transactional database. A general diagram of the present invention is shown in FIG. 17.

In the preferred embodiment of the present invention, the mobile device application may include voice operation control. This is a voice command system, possibly similar to the Apple iOS Siri, which is capable of executing functions upon recognition of audio commands. In the invention's preferred embodiment, there will be voice operational control for all aspects of the present invention's major functions. The shopper would simply have to issue a recognizable voice command to execute various functions. Alternative or future embodiments of the invention may include updates to the voice operation control process to improve voice recognition and other performance factors.

Another component in the preferred embodiment of the present invention is biometric security authentication. In the invention's preferred embodiment, this biometric security authentication is used to log into he invention securely. Biometric security authentication measures may include but are not limited to: fingerprint, palm veins, face recognition, palm print, hand geometry, iris recognition and retina. Notably, alternative or future embodiments of the invention may utilize other security authentication measures other than biometric, including but not limited to: RSA key, password, or future authentication technologies.

The present invention presents coupons from several participating manufacturers for a shopper to choose from, in the form of a “reverse micro auction.” The shopper selects coupon and item based on various criteria such as best value, lowest price, brand loyalty, and other features. The reverse micro auction process is a feature which allows product manufacturers to compete for market share via iterative coupon offers.

Shopping items are collected throughout the store and coupons are redeemed at checkout through the store's electronic check out services. Manufacturers set a coupon discount based on a variety of data, such as shopper demographics and/or geographic location, desire to maintain market share, win back lost market share, or to enter a new market. Coupons are further tailored to individual shoppers based on demographic criteria such as age, income level, gender, and other data.

In terms of usage, the user would view the invention's graphical user interface. The user would view multiple manufacturers of similar products auctioning digital coupons for their products. The user sees that certain coupon offers have greater cost savings than others, and selects the most suitable one. These coupon offers would be bids from different manufacturers.

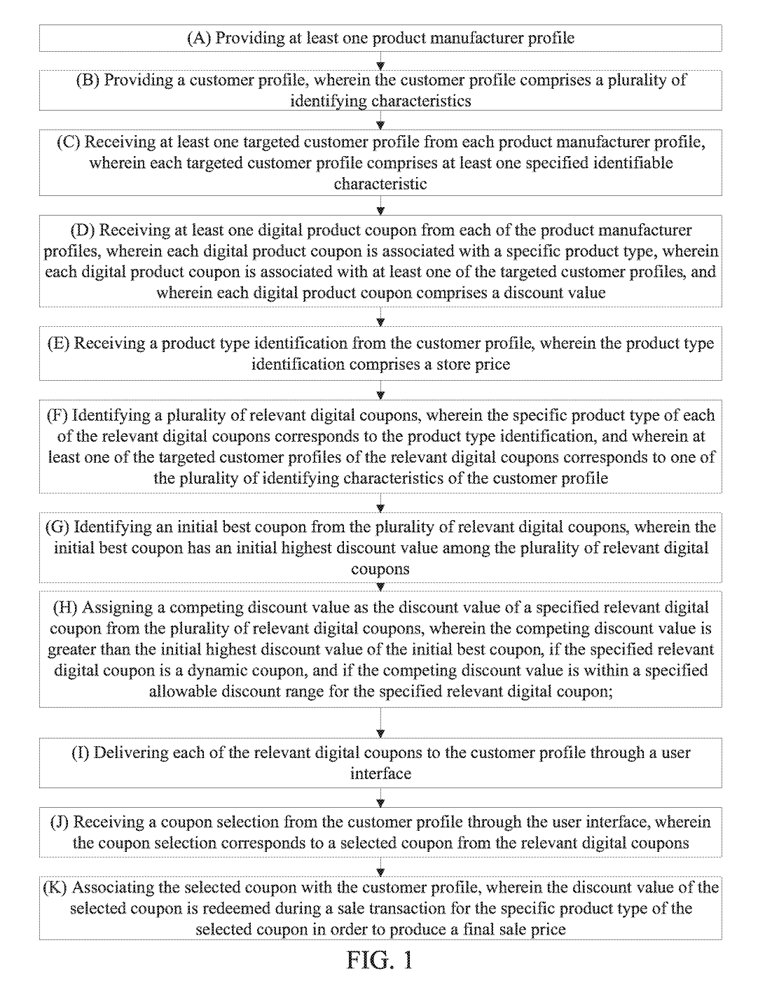

In the general method of the present invention shown in FIG. 1, at least one product manufacturer profile and a customer profile are provided. The customer profile comprises a plurality of identifying characteristics. The identifying characteristics of the customer profile indicate various demographic and other attributes that can be used to identify and sort the customer profile, such as, but not limited to, age, gender, income level, education level, marital status, geographical locations, and other factors. Said characteristics are entered into the mobile device application of the customer's mobile device in order to initialize the customer profile.

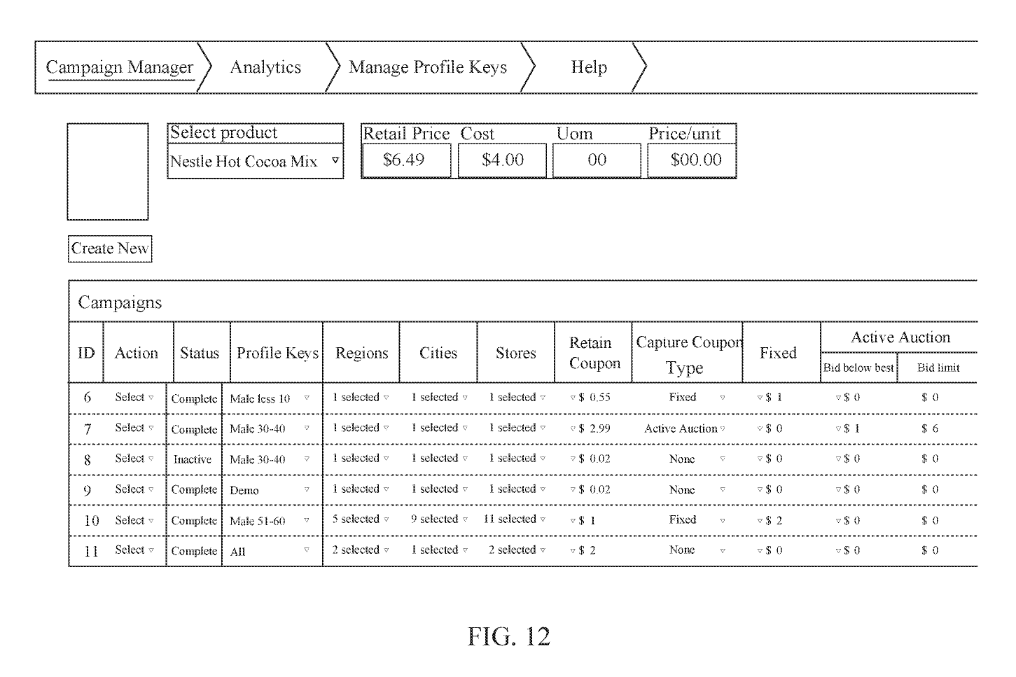

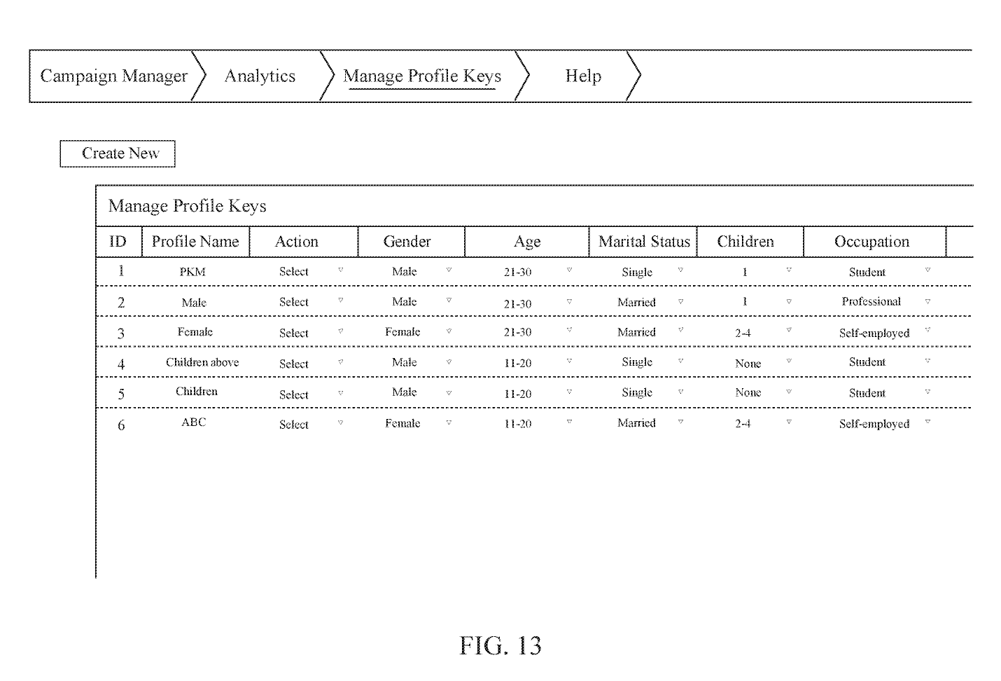

Initially, each product manufacturer profile initializes their coupon campaigns in the database and system of the present invention through a manufacturer portal as shown in FIGS. 12-13. The manufacturer portal provides the ability for manufacturers to track coupon wins and losses. Manufacturers' coupon wins/losses are tracked through the database, allowing the manufacturers to analyze and adjust future offerings to demographics. The manufacturer portal is preferably a web interface accessed through a web browser on a computer, though any other useful access means may be utilized, such as a desktop application. The manufacturers can create coupon campaigns specifically designed to retain or capture customers or targeted toward active customers, and deliver promotional targeting based on demographics. Manufacturers also upload information about all their products to the database, and are able to view analytics to evaluate success of their coupon campaigns.

Retail stores may interact with the system of the present invention in a similar way. Stores may also create promotional campaigns, create campaigns aimed toward cross-selling or up-selling various products, tie in to existing loyalty programs, advertise based on customer shopping patterns and groups, create coupon campaigns for store brand products, upload the store's product database, and view analytics to evaluate the success of their promotional campaigns. In many capacities herein, retail stores and product manufacturers may share the same abilities and in many cases, where a product manufacturer is referenced, it should be implicitly understood that a retail store may serve the same function or have the same abilities.

Manufacturers may choose to designate static or dynamic digital coupons. Static coupons deliver a fixed discount value such as a specified dollar amount or a percentage amount. Dynamic coupons have their discount value assigned in the reverse micro auction upon being compared to other coupons displayed to the customer.

To this end, at least one targeted customer profile is received from each product manufacturer profile, wherein each targeted customer profile comprises at least one specified identifiable characteristic. The identifiable characteristics may be demographic characteristics or other characteristics, such as, but not limited to, geographical characteristics.

At least one digital product coupon is received from each of the product manufacturer profiles, wherein each digital product coupon is associated with a specific product type and with at least one of the targeted customer profiles, and wherein each digital coupon comprises a discount value. For example, a digital product coupon may have a product type of beans, and a discount value of 50 cents.

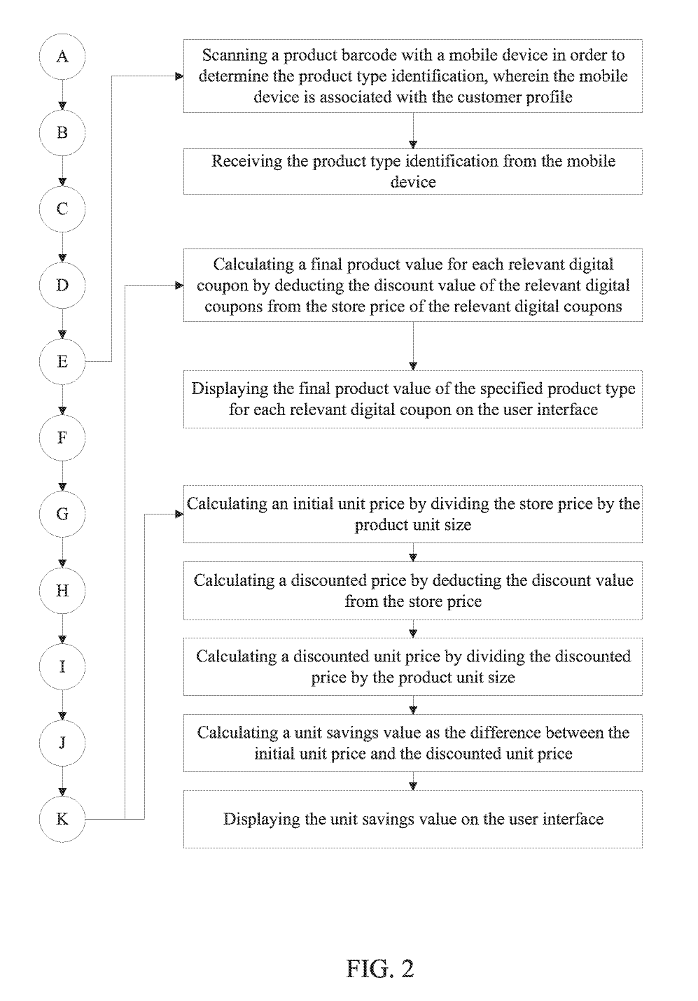

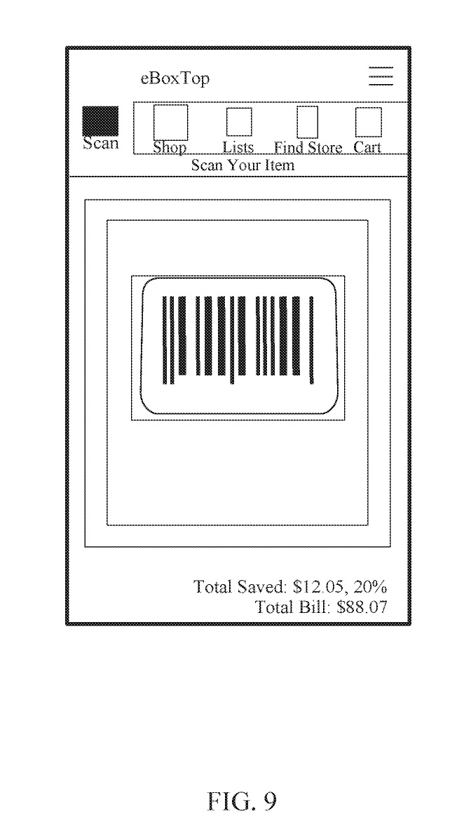

The next step in the process is a customer utilizing the mobile device application of the present invention to select a coupon for a product they wish to purchase. Thus, a product type identification is received from the customer profile. In the preferred embodiment of the present invention, the customer scans a barcode in order to initiate the product type identification, as shown in FIGS. 2 and 9. However it is contemplated that other means may be used thereto, such as, but not limited to, manually entering a text code. The product type identification additionally comprises a store price, wherein the store price is the initial cost of the item scanned as set by the store before any coupons are applied.

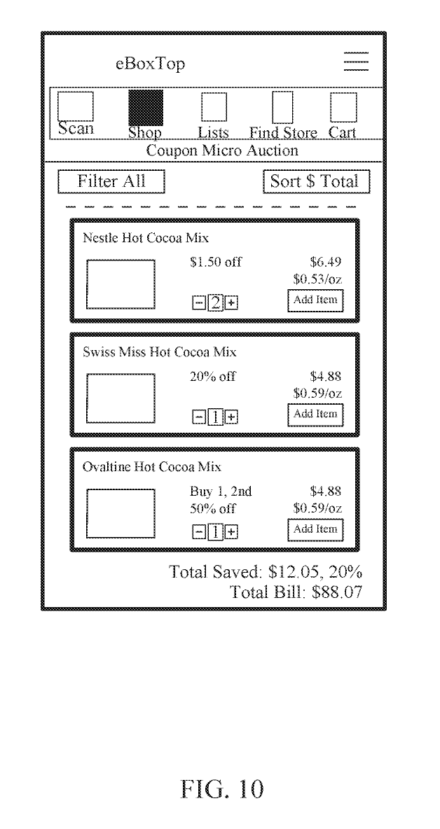

Once the product type identification is received, a plurality of relevant digital coupons is identified, as illustrated in FIG. 10. The specific product type of each of the relevant digital coupons corresponds to the product type identification, and at least one of the specified identifiable characteristics of the relevant digital coupons corresponds to one of the plurality of identifying characteristics of the customer profile. Any applicable means may be utilized to identify the relevant digital coupons, such as searching the database by product type, or by identifiable characteristics, or by other factors, or any combination thereof. This is where the reverse micro auction begins.

An initial best coupon is then identified from the plurality of relevant digital coupons, wherein the initial best coupon has an initial highest discount value among the plurality of relevant digital coupons. If a specified relevant coupon from the plurality of relevant coupons is a dynamic coupon, a competing discount value may be assigned as the discount value of the specified relevant digital coupon, wherein the competing discount value is greater than the initial highest coupon value of the initial best coupon. This is essentially a “bid” by the manufacturer associated with the specified relevant digital coupon to provide the best discount and acquire the customer's business. This step may be repeated many times if several of the relevant digital coupons are dynamic coupons. Thus, this process is essentially a reverse auction - as opposed to increasing a bid in an attempt to buy a product, the bid is lowered in an attempt to sell a product.

The competing discount value is only assigned, however, if the competing discount value is within a specified allowable discount range for the specified relevant digital coupon. The specified allowable discount range may be set by the manufacturer. For example, a manufacturer may not allow the final price for their product to fall below a specified threshold such as a fixed price or a specified portion of the product's store price. The specified allowable discount range may be optional for the manufacturer to define.

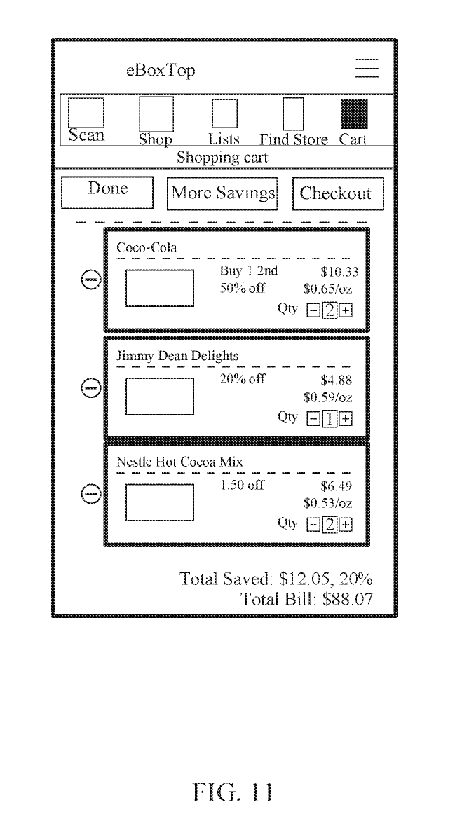

Each of the relevant digital coupons is delivered to the customer profile through a user interface; namely, through the application on the customer's mobile device. The customer browses the list of relevant digital coupons, each displaying their discount value, and chooses a coupon. The customer may sort the list of relevant digital coupons by any desirable metric, such as, but not limited to, value, price, discount, or size. A coupon selection is received from the customer profile through the user interface, wherein the coupon selection corresponds to a selected coupon from the relevant digital coupons. The selected coupon is associated with the customer profile; more specifically, the product associated with the selected coupon is added to a “shopping list” within the application on the customer's mobile device. The discount value of the selected coupon is then redeemed during a sale transaction for the specific product type of the selected coupon in order to produce a final sale price. An example of coupons applied to the shopping list is shown in FIG. 11.

Referring to FIG. 2, the value of the digital coupons is further determined by the store price of the product. A final product value for each relevant digital coupon is calculated by deducting the discount value of the relevant digital coupons from the store price of the relevant digital coupons, and the final product value of the specified product type for each of the relevant digital coupons is displayed on the user interface. Alternatively, only the relative discount value for each coupon may be displayed, or both the discount value and the final product value.

Each product has a product unit size, which is communicated through the product type identification. An initial unit price may be calculated by dividing the store price by the product unit size, and a discounted price for the product is then calculated by deducting the discount value from the store price. Subsequently, a discounted unit price is calculated by dividing the discounted price by the product unit size, a unit savings value is calculated as the difference between the initial unit price and the discounted unit price, and the unit savings value is displayed on the user interface. This allows the customer to evaluate coupon value by comparing price per unit size or volume between the relevant coupons.

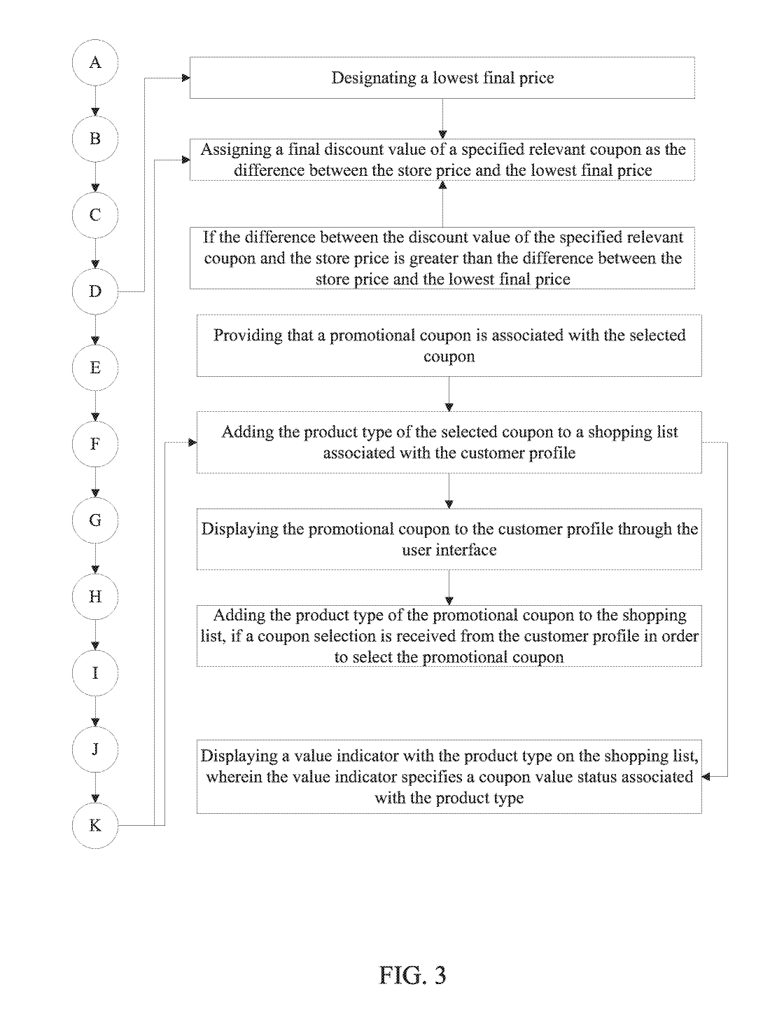

Referring to FIG. 3, the final price in a store for a product is also a controllable limit. A lowest final price may be designated either by the manufacturer or by the store. If the difference between the discount value of the specified relevant coupon and the store price is greater than the difference between the store price and the lowest final price (alternatively stated, if a coupon's discount value would bring the final price of a product below the lowest final price), a final discount value of a specified relevant coupon is assigned as the difference between the store price and the lowest final price, if the lowest final price is designated.

The present invention also enables the delivery of promotional coupons to the customer. Either the manufacturer or the store may associate a promotional coupon with a given product or coupon. The system's algorithm detects which products are commonly purchased by shoppers and which products are commonly purchased together. The system thus makes product recommendations to shoppers based on this information. Manufacturers can also manually link their items together so associated items will likely appear on shoppers' recommendation lists. When the product type of the selected coupon is added to the shopping list associated with the customer profile, the promotional coupon is displayed to the customer profile through the user interface. For example, if a hot cocoa product is added to the shopping list, a coupon for marshmallows may be suggested. If a coupon selection is received from the customer profile in order to select the promotional coupon, the product type of the promotional coupon is added to the shopping list. Promotional coupons may also be defined by either the manufacturer or the store which are not relevant to any particular product in the shopping list, and may simply serve the purpose of promoting a singular product. Furthermore, manufacturers can also engage in premium advertising within this system. This means that the manufacturer can directly link their products to shopper recommendation lists based on association, instead of relying solely on the algorithm itself.

Additionally, there may be a separate listing for promotions and promotional coupons within the mobile device application, where the customer can browse any current promotions.

The shopping list of the present invention enables a user to view all products they have selected for purchase. When the customer selects the selected coupon, the product type of the selected coupon is added to the shopping list associated with the customer profile. Items may be added to the shopping list in a variety of ways. An item may be added to the shopping list by the customer choosing a promotional coupon, or some other coupon which may be delivered to the customer in a manner other than scanning a product's barcode using the mobile device. In one embodiment of the present invention, items may also be added to the shopping list by manual text entry, which may be interpreted by the software in order to identify a specific product. In another embodiment, lists of products are provided in the mobile device application, using which the customer may navigate from general categories to more specific categories and to specific products. The shopping list also enables the creation of one or more shopping lists, which can be added, deleted, sorted, renamed, deactivated and reactivated.

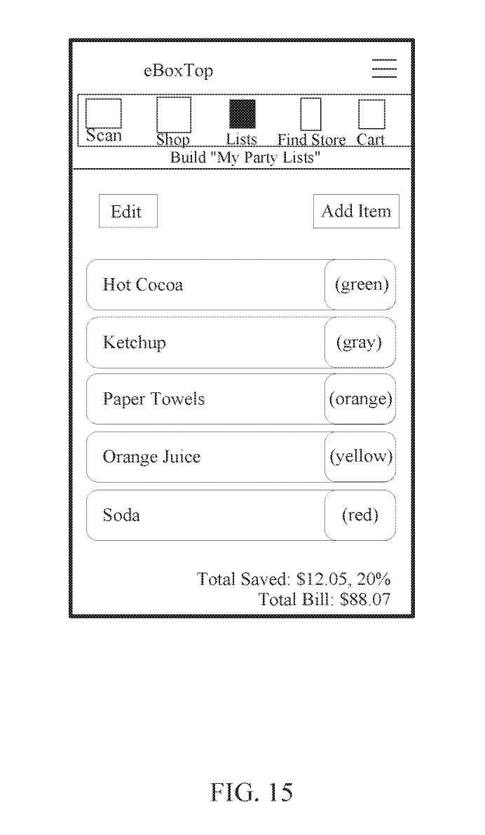

In the preferred embodiment of the present invention, a value indicator is displayed with the product type on the shopping list, as shown in FIG. 15. The value indicator specifies a coupon value status associated with the product type. The value indicator specifies, preferably by color-coding, number or letter rating or by another means, a status such as, but not limited to, the following: the best coupon for the product has been selected, no coupon has been selected, the least best coupon has been selected, a better (but not best) coupon has been selected, or attention is needed because a coupon is available.

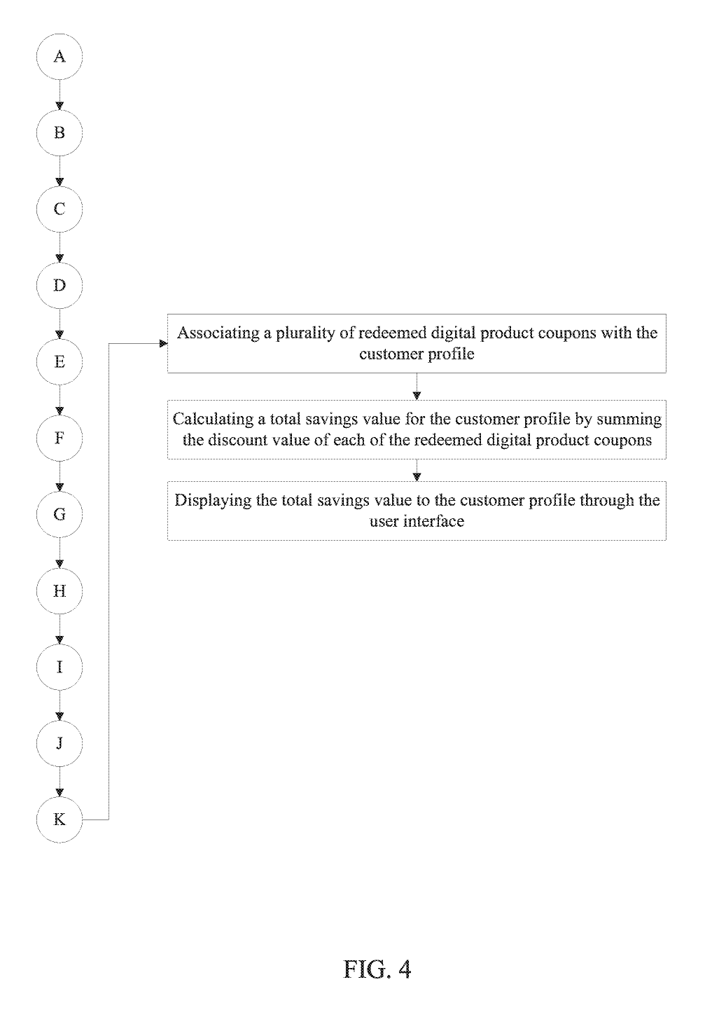

Referring to FIG. 4, the present invention provides an interface for the customer to view their savings history through a savings tracker feature while utilizing the present invention. After the customer has redeemed a plurality of digital coupons and the plurality of redeemed digital product coupons have been associated with the customer profile (or at any point) a total savings value is calculated for the customer profile by summing the discount value of each of the redeemed digital product coupons. Upon viewing the savings history interface in the mobile device application of the present invention, the total savings value is displayed to the customer profile through the user interface. In the preferred embodiment, the savings tracker records the customer's transactions and pertinent data, including but not limited to: location of point of sale, date and time of the transaction, amount of money spent, parties involved, etc. The savings tracker can keep records covering a lifetime, yearly, and/or monthly, timeframe, with other intervals possibly in alternative or future embodiments. The savings tracker may be tied into the current shopping list. In the invention's preferred embodiment, this may include listing of related items in the shopping list per entry. Alternative or future embodiments may include other features tied into the current shopping list.

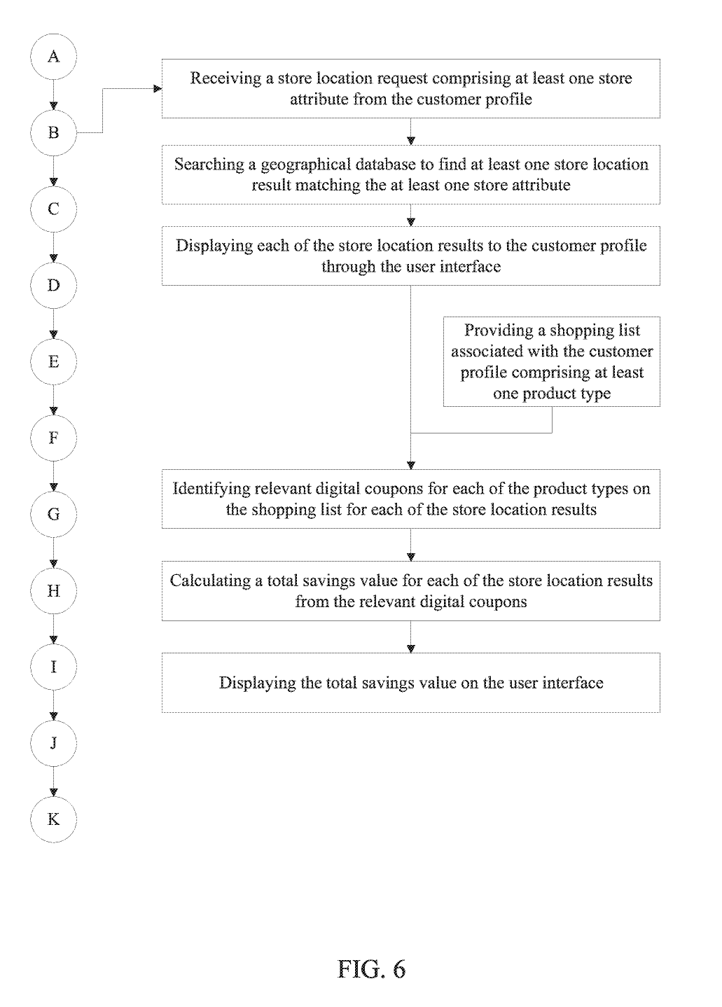

Referring to FIG. 6, another feature of the present invention is a store locator feature. A store location request is received from the customer profile after the customer profile inputs at least one store attribute, such as, but not limited to, store location or having a specific product in stock, and a geographical database or store database is searched to find at least one store location result matching at least one of or all of the inputted store attributes. Each of the store location results is displayed to the customer profile through the user interface on a map display in the mobile device application. Additionally, based on a customer's shopping list and calculated total savings at each store, the customer may compare total estimated and discounted price at each store. To this end, provided that the shopping list of the customer profile comprises at least one product type, relevant digital coupon are identified for each of the product types on the shopping list for each of the store location results. A total savings value is then calculated for each of the store location results from the relevant digital coupons of each of the store location results, and the total savings value is displayed on the user interface.

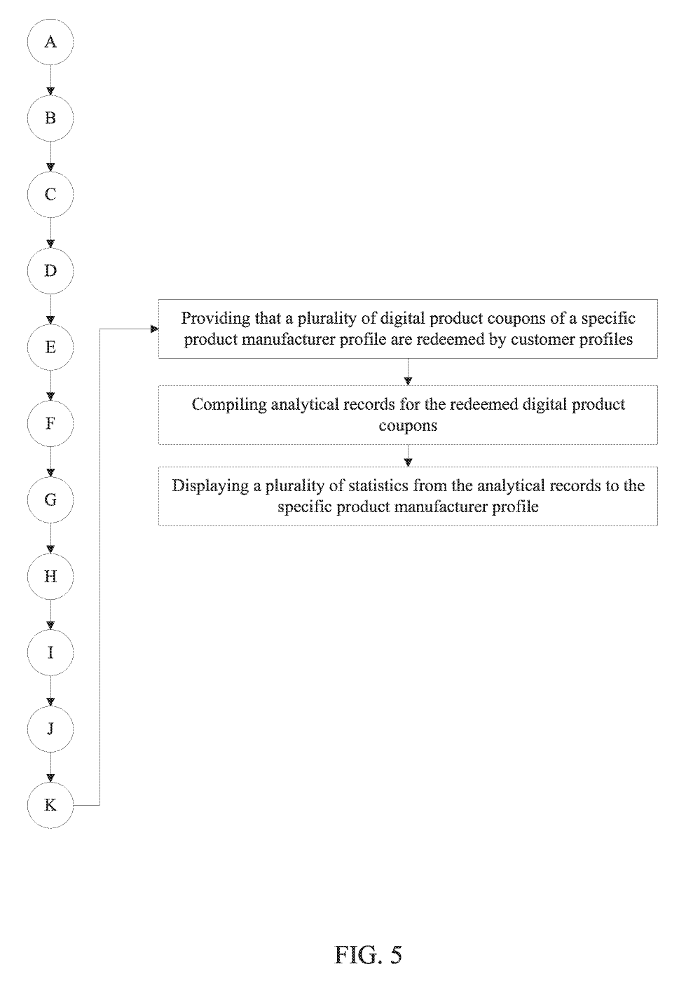

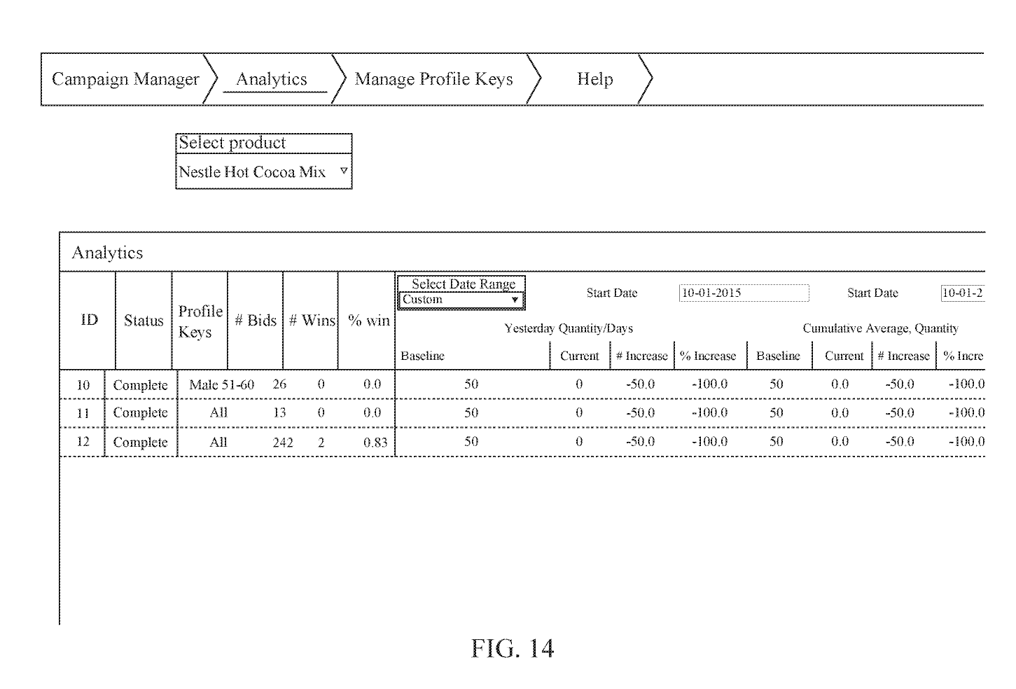

Referring to FIGS. 5 and 14, through the manufacturer portal, manufacturers may inspect and evaluate the effectiveness of their product coupon campaigns. After at least one, or a plurality of digital product coupons of a specific product manufacturer profile are redeemed by customer profiles, analytical records are compiled for the redeemed digital product coupons. More specifically, the analytical records are updated after each redemption of a digital product coupon. A plurality of statistics from the analytical records are displayed to the specific manufacturer profile. The statistics of the analytical records include statistics such as, but not limited to, percent increase or decrease in coupon redemption and changes in revenue and/or profit.

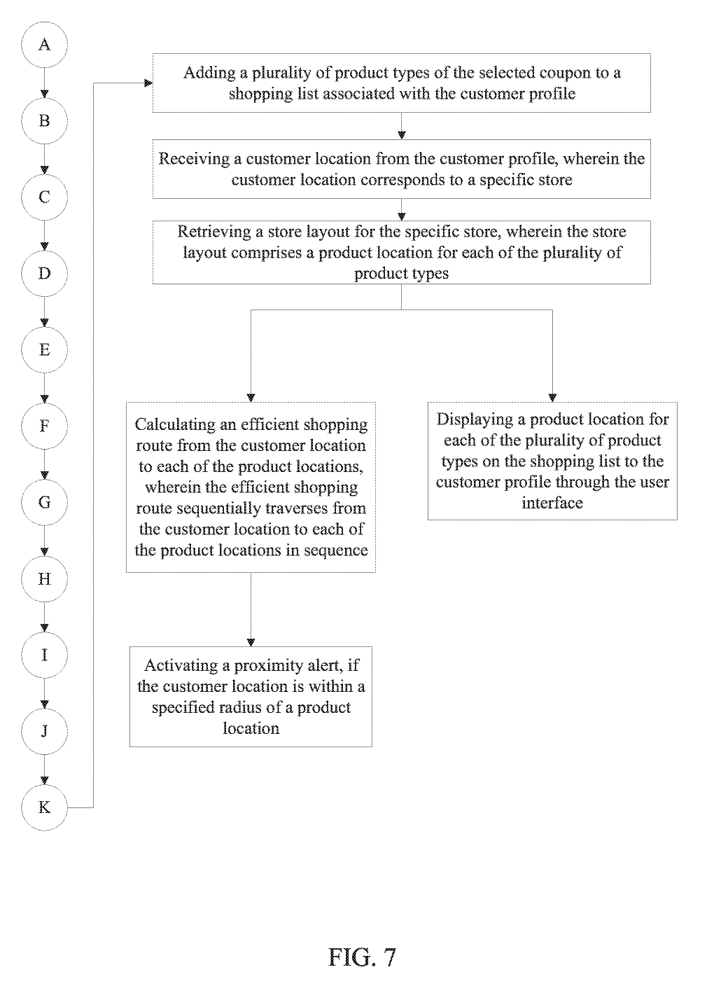

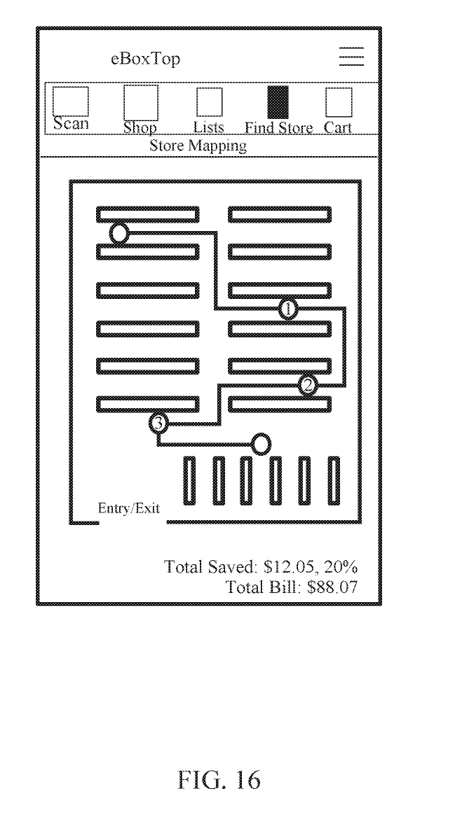

Referring to FIGS. 7 and 16, another feature of the present invention is a store mapping screen in the mobile device application. The store mapping screen allows the customer to map the most time efficient route to procure items on their shopping list. After a plurality of product types are added to the shopping list, a customer location is received from the customer profile, wherein the customer location indicates the physical location of a computing device associated with the customer profile (more particularly, the customer's mobile device) inside a specific store. The customer location may be automatically retrieved from the global positioning system of the mobile device, or the customer may input their current location on a store layout, or by another means. A store layout is retrieved for the specific store, and a product location is displayed to the customer profile through the user interface for each of the plurality of product types on the shopping list. An efficient shopping route is calculated from the customer location to each of the product locations. The efficient shopping route sequentially traverses from the customer location, to each of the product locations in sequence, and to a checkout location within the store. The efficient shopping route is displayed to the customer profile on the store layout on the user interface of the mobile device application. In the preferred embodiment, the mobile device application is additionally integrated with the vibration and audio drivers of the customer's mobile device, and may thus provide various alerts the customer, such as, but not limited to, vibrating or playing an audio tone or message if the mobile device is in close proximity to one of the items on the shopping list. This feature may be particularly beneficial for customers with various disabilities.

In the preferred embodiment, a proximity alert is activated if the customer location is within a specified radius of a product location. As the customer approaches the location of a pre-determined product, the mobile device may vibrate with increasing frequency and/or intensity to inform the customer that they are in greater proximity to the product. Similarly and simultaneously or alternatively, as the customer approaches the location of a pre-determined good, the mobile device may issue an audio alert with increasing volume and/or intensity to inform the customer that they are in greater proximity to the product. Notably, this methodology may include sub-processes which take into account ambient noise. The methodology may take input from the microphone to measure the level of ambient noise, and adjust the output volume and/or frequency to make the audio alert easier to hear. Alternative or future embodiments of the invention may use different algorithms to accommodate the ambient noise.

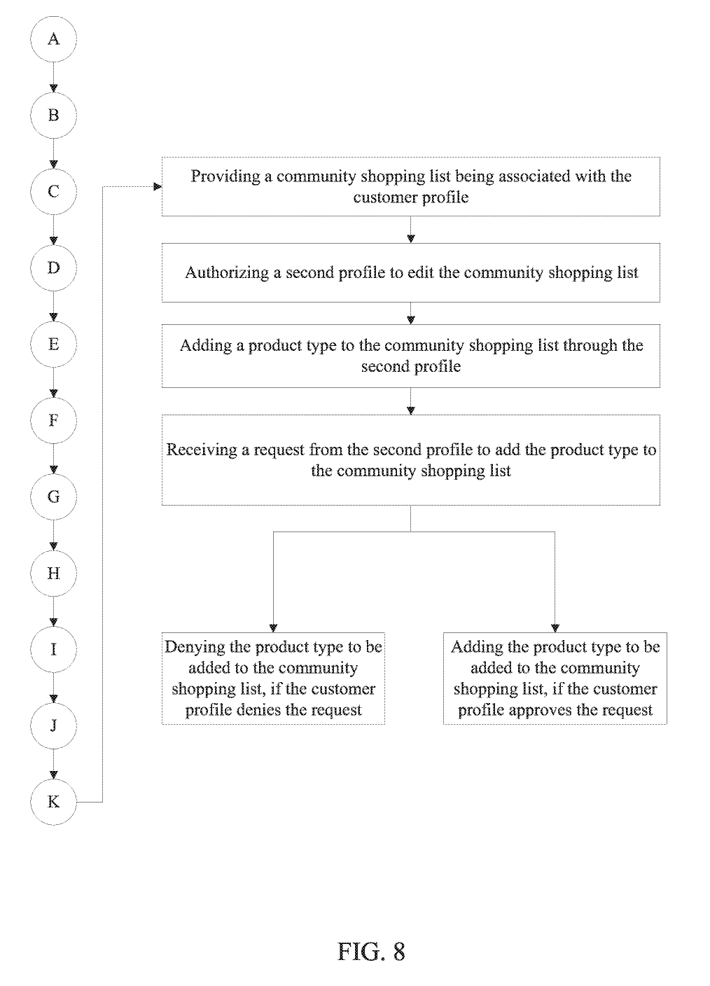

Referring to FIG. 8, another feature of the present invention is a community shopping list function. The community shopping list function allows other shoppers to contribute to the owner's community shopping list once granted permission. The owner of a community shopping list can give authorization to other shoppers who can request items to be added to the owner's community list. For example, children may request through the invention that a parent add candy to the community list. The community list owner can accept, defer, or deny the request via the user interface.

Notably, the present invention also has a set of Software/Hardware Drivers for the present invention. These elements interact with the hardware elements of mobile devices. These drivers comprise of: a voice operation control, accelerometer operation control, vibration navigation location mode, audio navigation location mode, and biometric security authentication.

The first major driver is for the voice operation control. Again, the voice operation control allows the user to issue audio commands to execute functions within the present invention's system. These functions encompass the major features of the present invention.

Notably, the driver for the voice operation control is a uniquely developed mobile device hardware/software driver. It interfaces with the microphone hardware entity of the mobile device running the invention.

The mobile device microphone hardware typically has an “on to record” mode only. The driver has a tailored calibration mode, in which the user is requested to verbalize several words read from a predetermined list. Words are chosen to measure key speech elements of the user such as tone, delivery duration, amplitude, and frequency spectrum. The hardware/software driver registers the calibrated key words for later usage.

Notably, the present invention's higher-level software calls upon the voice control hardware/software driver when input is desired for function control, such as creating/manipulating the shopping list, entering into/selecting the reverse micro auction, and navigating the various pages of the app.

Furthermore, the voice control hardware/software driver allows accurate and flexible operation of the present invention. It complements or replaces the touch screen entry operation, and enables a greater level of control needed for physically impaired shoppers. The driver allows hands-free operation while the shopper navigates through the store.

The next major driver is for the accelerometer operation control. The driver pertains to the software affecting the mobile device's accelerometer and the invention's processes which utilize it.

Notably, this driver is specifically developed for the present invention, and interfaces with the accelerometer hardware entity of the mobile device.

Mobile devices typically contain embedded accelerometer hardware for X, Y, Z orthogonal motion detection. The driver for the invention's Accelerometer operation control taps into this hardware to detect and measure motion movement of the mobile device. Motions tracked include rest position to motion translated to forward/backward, left/right, and up/down movement or combination thereof.

The driver has a calibration mode in which user is requested to “flick” motion in each direction from a predetermined list. This motion is measured, and the hardware/software driver registers and keys movement unique to the specific user for use later during operation mode.

The driver calls upon the accelerometer hardware/software driver when input is desired for function control such as creating/manipulating the shopping list, entering into/selecting the reverse micro auction, and navigating the various pages of the app. For example: a forward “flick” could be used to indicate scrolling up on a list, and a backward flick for scrolling down on a list. A right flick could indicate “select” of an item highlighted on mobile device screen, a left flick used to indicate “reject” of an item. Alternative or future embodiments may utilize a different control scheme.

The accelerometer hardware/software driver allows accurate and flexible operation of the present invention. Like the voice operation control, it complements touch screen entry operation, and enables a greater level of control needed for physically impaired shoppers. The driver allows hands-free operation while the shopper navigates through the store.

The next major driver is for the vibration navigation location mode. As mentioned, this mode aids mapping of product locations within a store. The mode utilizes pulse rate modulation to indicate whether the closer/further from the user.

Mobile device vibration hardware typically has only on/off control. The driver controls the vibration mode of the embedded hardware through a pulse width modulation algorithm, to increase the frequency and duration of vibration.

The invention's higher-level software calls upon the vibration control driver to identify/confirm a closer/further indication when traveling through store searching for product on shopper list. This function is combined with the store mapping function for destination location whereas the mobile device vibrates at a slow rate (example: once per 4 sec.) progressing faster (example: once per 3 sec, 2 sec, 1 sec) as shopper gets closer. If the shopper is heading in wrong direction, the vibration rate gets slower. Once the shopper is within “found” radii, the mobile device vibrates very fast or constantly until the signal condition is registered as “found,” and vibration ceases.

The vibration control hardware/software driver allows accurate and flexible operation of the invention. The vibration system complements the visual mapping operation to enable a greater level of control needed for physically impaired shoppers, and provides biofeedback as a guide shoppers navigating through the store.

The next major driver is for the audio navigation location mode. This mode has automatic audio modulation to aid mapping of product locations within a store, with sound level adjustment based on ambient noise. This is a tailored driver which interfaces with the speaker/microphone hardware entities of the mobile device.

Typically, mobile device audio speaker hardware has manual control for high/low volume adjust. The invention's audio automatic modulation driver controls the audio mode of the embedded speaker hardware, utilizing a closed loop auto volume adjust with microphone feedback algorithm to modulate the speaker volume to be proportional with the ambient environmental background noise.

The invention's higher level software calls upon the audio automatic modulation hardware/software driver to identify/confirm a closer/further indication when the user travels through the store, searching for a product on his/her shopping list. This function is combined with the store mapping function for determining the destination location. During this process, the mobile device “beeps” at a slow rate (example: once per 4 sec.) progressing faster (example: once per 3 sec, 2 sec, 1 sec) as shopper gets closer. If the shopper is heading in the wrong direction, the beep rate gets slower. Once within “found” radii, the mobile device beeps very fast or constantly until the product has been registered as “found.” The invention then stops the beeping. The “beep” volume level is set to an initial acceptable level by the shopper, and as the ambient background noise increases/decreases, the drive automatically performs a proportional increase/decrease in speaker volume.

As with the other drivers, the audiomatic auto modulation hardware/software driver allows accurate and flexible operation of invention, complementing the visual mapping operation. This enables a greater level of control needed for physically impaired shoppers, or simply improved operation to aid shoppers navigating through the store.

The last major driver is for the biometric security authentication system. As aforementioned, the biometric security authentication is used to log into to the app securely. Methods includes but are not limited to: fingerprint, palm veins, face recognition, palm print, hand geometry, iris recognition and accelerometer based security code entry. This driver interfaces with the finger print scanning hardware entity, camera hardware entity, light illumination hardware entity, and accelerometer hardware entity of the mobile device.

Mobile devices typically contain a plethora of embedded hardware with security authentication capabilities. The invention taps into this hardware to detect various biometric characteristics of the user.

The driver has a calibration mode in which user is requested to: take a facial picture of user to register user baseline, take a palm picture of user hand to register user baseline, “flick” motion in each X, Y, Z orthogonal direction from a predetermined list to register user baseline, and take a finger print scan of the user's thumb or index finger to register user baseline.

The invention's higher-level software calls upon the biometric hardware/software driver when input is desired for security authentication by having the user repeat required biometric security characteristics, to compare to items stored in the baseline. The system then makes an authentication determination based on the data.

The biometric security authentication hardware/software driver thus allows accurate and positive user identification. This process is useful in logging onto the user specific account, and provides an addition security mechanism for monetary transactions.

Although the invention has been explained in relation to its preferred embodiment, it is to be understood that many other possible modifications and variations can be made without departing from the spirit and scope of the invention as hereinafter claimed.

What is claimed is:

1. A method of generating and delivering digital product coupons through reverse micro coupon auctions by executing computer-executable instructions stored on a non-transitory computer-readable medium comprises the steps of:
providing at least one product manufacturer profile;
providing a customer profile, wherein the customer profile comprises a plurality of identifying characteristics;
receiving at least one targeted customer profile from each product manufacturer profile, wherein each targeted customer profile comprises at least one specified identifiable characteristic;
receiving at least one digital product coupon from each of the product manufacturer profiles, wherein each digital product coupon is associated with a specific product type, wherein each digital product coupon is associated with at least one of the targeted customer profiles, and wherein each digital product coupon comprises a discount value;
receiving a product type identification from the customer profile, wherein the product type identification comprises a store price;
identifying a plurality of relevant digital coupons, wherein the specific product type of each of the relevant digital coupons corresponds to the product type identification, and wherein at least one of the targeted customer profiles of the relevant digital coupons corresponds to one of the plurality of identifying characteristics of the customer profile;
identifying an initial best coupon from the plurality of relevant digital coupons, wherein the initial best coupon has an initial highest discount value among the plurality of relevant digital coupons;
assigning a competing discount value as the discount value of a specified relevant digital coupon from the plurality of relevant digital coupons, wherein the competing discount value is greater than the initial highest discount value of the initial best coupon, if the specified relevant digital coupon is a dynamic coupon, and if the competing discount value is within a specified allowable discount range for the specified relevant digital coupon;
delivering each of the relevant digital coupons to the customer profile through a user interface;
receiving a coupon selection from the customer profile through the user interface, wherein the coupon selection corresponds to a selected coupon from the relevant digital coupons; and
associating the selected coupon with the customer profile, wherein the discount value of the selected coupon is redeemed during a sale transaction for the specific product type of the selected coupon in order to produce a final sale price.

2. The method of generating and delivering digital product coupons through reverse micro coupon auctions by executing computer-executable instructions stored on a non-transitory computer-readable medium as claimed in claim 1 comprises the steps of:
scanning a product barcode with a mobile device in order to determine the product type identification, wherein the mobile device is associated with the customer profile; and
receiving the product type identification from the mobile device.

3. The method of generating and delivering digital product coupons through reverse micro coupon auctions by executing computer-executable instructions stored on a non-transitory computer-readable medium as claimed in claim 1 comprises the steps of:
calculating a final product value for each relevant digital coupon by deducting the discount value of the relevant digital coupons from the store price of the relevant digital coupons; and
displaying the final product value of the specified product type for each relevant digital coupon on the user interface.

4. The method of generating and delivering digital product coupons through reverse micro coupon auctions by executing computer-executable instructions stored on a non-transitory computer-readable medium as claimed in claim 1 comprises the steps of:
providing that the product type identification comprises a product unit size;
calculating an initial unit price by dividing the store price by the product unit size;
calculating a discounted price by deducting the discount value from the store price;
calculating a discounted unit price by dividing the discounted price by the product unit size;
calculating a unit savings value as the difference between the initial unit price and the discounted unit price; and
displaying the unit savings value on the user interface.

5. The method of generating and delivering digital product coupons through reverse micro coupon auctions by executing computer-executable instructions stored on a non-transitory computer-readable medium as claimed in claim 1 comprises the steps of:
designating a lowest final price; and
assigning a final discount value of a specified relevant coupon as the difference between the store price and the lowest final price,
if the difference between the discount value of the specified relevant coupon and the store price is greater than the difference between the store price and the lowest final price.

6. The method of generating and delivering digital product coupons through reverse micro coupon auctions by executing computer-executable instructions stored on a non-transitory computer-readable medium as claimed in claim 1 comprises the steps of:
providing that a promotional coupon is associated with the selected coupon;
adding the product type of the selected coupon to a shopping list associated with the customer profile;
displaying the promotional coupon to the customer profile through the user interface; and
adding the product type of the promotional coupon to the shopping list, if a coupon selection is received from the customer profile in order to select the promotional coupon.

7. The method of generating and delivering digital product coupons through reverse micro coupon auctions by executing computer-executable instructions stored on a non-transitory computer-readable medium as claimed in claim 1 comprises the steps of:
adding the product type of the selected coupon to a shopping list associated with the customer profile; and
displaying a value indicator with the product type on the shopping list, wherein the value indicator specifies a coupon value status associated with the product type.

8. The method of generating and delivering digital product coupons through reverse micro coupon auctions by executing computer-executable instructions stored on a non-transitory computer-readable medium as claimed in claim 1 comprises the steps of:
associating a plurality of redeemed digital product coupons with the customer profile;
calculating a total savings value for the customer profile by summing the discount value of each of the redeemed digital product coupons; and
displaying the total savings value to the customer profile through the user interface.

9. The method of generating and delivering digital product coupons through reverse micro coupon auctions by executing computer-executable instructions stored on a non-transitory computer-readable medium as claimed in claim 1 comprises the steps of:
receiving a store location request comprising at least one store attribute from the customer profile;
searching a geographical database to find at least one store location result matching the at least one store attribute; and
displaying each of the store location results to the customer profile through the user interface.

10. The method of generating and delivering digital product coupons through reverse micro coupon auctions by executing computer-executable instructions stored on a non-transitory computer-readable medium as claimed in claim 9 comprises the steps of:
providing a shopping list associated with the customer profile comprising at least one product type;
identifying relevant digital coupons for each of the product types on the shopping list for each of the store location results;
calculating a total savings value for each of the store location results from the relevant digital coupons; and
displaying the total savings value on the user interface.

11. The method of generating and delivering digital product coupons through reverse micro coupon auctions by executing computer-executable instructions stored on a non-transitory computer-readable medium as claimed in claim 1 comprises the steps of:
adding a plurality of product types of the selected coupon to a shopping list associated with the customer profile;
receiving a customer location from the customer profile, wherein the customer location corresponds to a specific store;
retrieving a store layout for the specific store, wherein the store layout comprises a product location for each of the plurality of product types; and
calculating an efficient shopping route from the customer location to each of the product locations, wherein the efficient shopping route sequentially traverses from the customer location to each of the product locations in sequence.

12. The method of generating and delivering digital product coupons through reverse micro coupon auctions by executing computer-executable instructions stored on a non-transitory computer-readable medium as claimed in claim 11 comprises the step of:
activating a proximity alert, if the customer location is within a specified radius of a product location.

13. The method of generating and delivering digital product coupons through reverse micro coupon auctions by executing computer-executable instructions stored on a non-transitory computer-readable medium as claimed in claim 1 comprises the steps of:
providing that a plurality of digital product coupons of a specific product manufacturer profile are redeemed by customer profiles;
compiling analytical records for the redeemed digital product coupons; and
displaying a plurality of statistics from the analytical records to the specific product manufacturer profile.

14. The method of generating and delivering digital product coupons through reverse micro coupon auctions by executing computer-executable instructions stored on a non-transitory computer-readable medium as claimed in claim 1 comprises the steps of:
adding a plurality of product types to a shopping list of the customer profile;
receiving a customer location from the customer profile, wherein the customer location indicates the location of a computing device associated with the customer profile inside a specific store;
retrieving a store layout for the specific store; and
displaying a product location for each of the plurality of product types on the shopping list to the customer profile through the user interface.

15. The method of generating and delivering digital product coupons through reverse micro coupon auctions by executing computer-executable instructions stored on a non-transitory computer-readable medium as claimed in claim 1 comprises the steps of:
providing a community shopping list being associated with the customer profile;
authorizing a second profile to edit the community shopping list; and
adding a product type to the community shopping list through the second profile.

16. The method of generating and delivering digital product coupons through reverse micro coupon auctions by executing computer-executable instructions stored on a non-transitory computer-readable medium as claimed in claim 15 comprises the steps of:
receiving a request from the second profile to add the product type to the community shopping list;
adding the product type to be added to the community shopping list, if the customer profile approves the request; and
denying the product type to be added to the community shopping list, if the customer profile denies the request.
